(19) United States
(12) Patent Application Publication
(10) Pub. No.: US 2010/0001929 A1
(43) Pub. Date: Jan. 7, 2010

(54) ACTIVE MATRIX DISPLAY DEVICE

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/524,879

(22) PCT Filed: Jan. 22, 2008
(86) PCT No.: PCT/US08/00792

§ 371 Date: Jul. 29, 2009

(30) Foreign Application Priority Data
Feb. 9, 2007 (JP) 2007-031136

(51) Int. Cl. G09G 3/20

(52) U.S. Cl. 345/55

(57) ABSTRACT

A data driver supplies data to a data line provided corresponding to a pixel column. A selection driver sequentially supplies a selection signal to a selection line provided corresponding to a pixel row. The selection driver has a shift register which receives a supply of a shift clock and sequentially transfers a selection signal to a register of a plurality of stages, and a plurality of switches which are connected to outputs of the stages of the register of the shift register and control supply of a selection signal to plurality of selection lines. By sequentially switching a plurality of switches connected to the output of the register ON while a selection signal is output from one register of the shift register, data is supplied to pixels arranged in a matrix form to a display array.

### FIELD OF THE INVENTION

The present invention relates to an active matrix display device in which data is supplied to pixels arranged in a matrix form and display is realized.

### BACKGROUND OF THE INVENTION

In an active matrix display device, data corresponding to each of a plurality of pixels arranged in a matrix form on a display panel is written to the pixel and display according to the data is realized. The data to be displayed (video data) is sequentially supplied from a top left pixel in the matrix to a bottom right pixel in synchronization with a horizontal synchronization signal and a vertical synchronization signal. By setting pixels of one line in a state to read data, sequentially outputting the data for the pixels to a data line provided corresponding to a pixel column, and sequentially changing the target line, it is possible to write data to the pixels.

In addition, there is also a method in which video data of one line is read in a register corresponding to each column, and video data of one line is output at once and read in pixels of the corresponding line. With such an output, sufficient data writing time can be secured in each pixel.

In an active matrix display device, a selection signal is sequentially output on selection lines provided corresponding to the lines and a selection transistor of each pixel connected to the selection line is switched ON, so that reading of data from a data line is controlled. For this purpose, one register stage of a shift register is assigned to each selection line, and by supplying a shift clock to the shift register to sequentially transfer the selection signal, the selection lines are sequentially selected and video data is written to the pixels on that line.

A structure of a gate driver in digital driving is described in, for example, WO2005116971(A1).

When a number of pixels is increased and a number of lines is increased, a shift register having a number of stages equal to the increased number of lines is required. For example, in a panel with 320 lines, a shift register having 320 stages is required and a shift register of 640 stages is required for a panel with 640 lines. In other words, when the resolution is increased, a shift register of a larger number of stages is required. On the other hand, it is desired to minimize the size of the display panel. When the size of the display panel is not changed although the number of pixels and lines are increased, the mounting area of the shift register becomes relatively small, and thus it becomes more difficult to mount the shift register.

For example, when the shift register is to be formed on a glass substrate, a larger number of shift registers must be realized in a same area. When the shift register is to be provided as a driver IC (Integrated Circuit) provided separately from the circuit on the glass substrate, a density of a connection section which connects an output of the driver IC and a terminal of the panel is increased, and the connection becomes difficult. In a case where no shift register is provided and a decoder which selects a line is provided, an increase in the number of lines results in an increased number of outputs, and a similar disadvantage occurs.

### SUMMARY OF THE INVENTION

According to one aspect of the present invention, there is provided an active matrix display device in which data is supplied to pixels arranged in a matrix to realize a display, the active matrix display device comprising a data driver which supplies data to a data line provided corresponding to a pixel column, and a selection driver which supplies a selection signal to a selection line provided corresponding to a pixel row, to control reading of data from a corresponding data line to a corresponding pixel, wherein the selection driver includes a selection signal generator which outputs a selection signal to outputs having a number smaller than a number of the selection lines, and a plurality of selection switches connected to one output of the selection signal generator and which connect the one output to a plurality of the selection lines, and a plurality of selection switches connected to an output is sequentially switched ON while a selection signal is output from the one output of the selection signal generator so that a selection signal is sequentially output to the plurality of selection lines.

According to another aspect of the present invention, it is preferable that, in the active matrix display device, the selection signal generator is a shift register which receives supply of a shift clock and which sequentially transfers a selection signal to a register of a plurality of stages.

According to another aspect of the present invention, it is preferable that, in the active matrix display device, the selection signal generator is a decoder which, when an arbitrary selection line is designated, generates a selection signal which selects a corresponding selection line.

According to another aspect of the present invention, it is preferable that, in the active matrix display device, the selection driver includes a retaining driver having a retaining switch which is connected to each selection line and which, when the selection switch of each selection line is switched OFF, connects the selection line to a power supply to delete the selection signal.

According to another aspect of the present invention, it is preferable that, in the active matrix display device, at least one of the selection switch and the retaining switch of the selection driver is formed on a glass substrate.

A feature of this invention is that it reduces a number of outputs of a selection signal outputting section.

According to various aspects of the present invention, it is possible to sequentially supply an output from a shift register to a plurality of gate lines. Therefore, a number of stages of the shift register can be reduced.

### BRIEF DESCRIPTION OF THE DRAWINGS

Preferred embodiments of the present invention will be described in detail by reference to the drawings, wherein:

FIG. 1 is a diagram showing an overall structure of an active matrix display device having a gate driver according to an embodiment of the present invention;

FIG. 2 is a driving timing chart of a gate driver according to an embodiment of the present invention;

FIG. 3 shows another example gate driver according to an embodiment of the present invention;

FIG. 4 is a diagram showing an overall structure of an active matrix display device having a gate driver of another embodiment of the present invention;

FIG. 5A is a diagram showing an equivalent circuit of a pixel when a static memory is provided in a pixel; and

FIG. 5B is a diagram showing placement and connection in a pixel circuit when a static memory is provided in a pixel, seen from a side opposite to a light emitting surface.

### DESCRIPTION OF THE PREFERRED EMBODIMENT

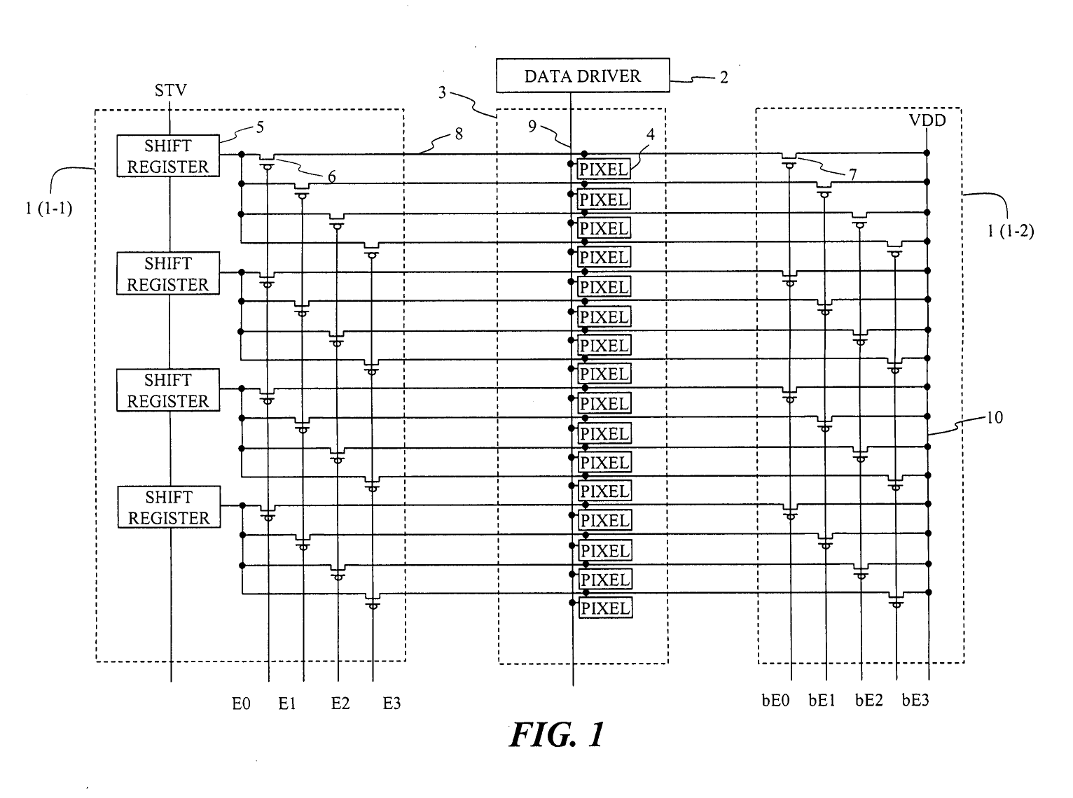

A preferred embodiment of the present invention will now be described referring to the drawings. FIG. 1 shows an example of an active matrix display device having a gate driver (selection driver) 1 of a preferred embodiment of the present invention.

A display device of FIG. 1 includes a gate driver 1 which is placed along a row direction and which controls selection of pixels for each horizontal line, a data driver 2 which controls supply of data to pixels of each column, and a pixel array 3 in which pixels 4 are arranged in a matrix form in column and row directions (only one column is shown in FIG. 1).

The gate driver 1 is functionally divided into a controller 1-1 which controls selection/non-selection of a gate line (selection line) 8 provided corresponding to each row of pixels and a retaining section 1-2 which retains non-selection of the gate line 8. The data driver 2 supplies a data signal corresponding to video data from the outside to a data line 9.

A pixel 4 in the pixel array 3 includes, for example, an organic electroluminescence (hereinafter simply referred to as “EL”) element as a display element, and the organic EL element emits light with a supplied data signal. For this purpose, the pixel 4 includes a gate transistor having a gate connected to the gate line and one terminal connected to the data line, a storage capacitor which is connected to another terminal of the gate transistor and which stores a data voltage, a driving transistor having a data voltage stored by the storage capacitor supplied on its gate and which allows a current corresponding to the data voltage to flow, and an organic EL element which emits light when current flowing through the driving transistor flows through the organic EL element. The display element is not limited to the organic EL element, and various elements can be used as the display element. For example, when a liquid crystal element is used, the driving transistor is not necessary, and a data voltage stored in the storage capacitor is applied to the liquid crystal element, to realize display.

In FIG. 1, the gate driver 1 is divided into the controller 1-1 and the retaining section 1-2 and placed at both ends of the pixel array 3 in consideration of the convenience of the structure of the display device. Alternatively, it is also possible to integrate the controller 1-1 and the retaining section 1-2 to form the gate driver 1.

The gate driver controller 1-1 includes a shift register 5 as a selection signal generator which generates a selection signal. A plurality of first switches (selection switches) 6 are connected to outputs of stages of the shift register 5, and different first switches 6 are connected to different gate lines 8. In the exemplified configuration, the first switch 6 is formed of a P-type transistor and controls connection between the shift register 5 and the gate line 8. Alternatively, the first switch 6 may be of N-type and/or a plurality of first switches 6 may be provided for each gate line 8. In FIG. 1, four consecutive gate lines 8 are connected to an output of the shift register 5 via the first switches 6.

Specifically, an Nth line, an (N+1)th line, an (N+2)th line, and an (N+3)th line are connected to an (N/4)th shift register 5 via first switches 6, wherein N is a positive integer and N/4 is also a positive integer.

Control lines E0, E1, E2, and E3 are connected to the gates of the four first switches 6 connected to the shift register 5. More specifically, a gate terminal of the first switch 6 connecting a line in which a remainder of N divided by 4 is “0” (multiple of 4) to the output of the (N/4)th shift register is connected to the control line E0, a gate terminal of the first switch 6 connecting a line in which the remainder is “1” to the output of the (N/4)th shift register is connected to the control line E1, a gate terminal of the first switch 6 connecting a line in which the remainder is “2” to the output of the (N/4)th shift register is connected to the control line E2, and a gate terminal of the first switch 6 connecting a line in which the remainder is “3” to the output of the (N/4)th shift register is connected to the control line E3.

In the retaining section 1-2, on the other hand, each gate line 8 is connected to an OFF power supply line 10, to which an OFF power supply (VDD) is supplied, via a second switch (retaining switch) 7 made of a P-type transistor. When the OFF power supply (VDD) is connected to the gate line 8, the gate line 8 is set at a non-selection state. At least one second switch 7 is provided for each gate line 8. In addition, a gate terminal of the second switch 7 of the Nth line is connected to a control line bE0 when a remainder of N divided by 4 is “0”, to bE1 when the remainder is “1”, to bE2 when the remainder is “2”, and to bE3 when the remainder is “3”.

Because a signal in which the control signal to each of the control lines E0-E3 is inverted is supplied to each of the control lines bE0-bE3, the gate line 8 is never simultaneously connected to both the output of the shift register 5 and the OFF power supply line 10. The gate line 8 is always connected to one of the output of the shift register 5 and the OFF power supply line 10, and is in one of the selection state or the non-selection state.

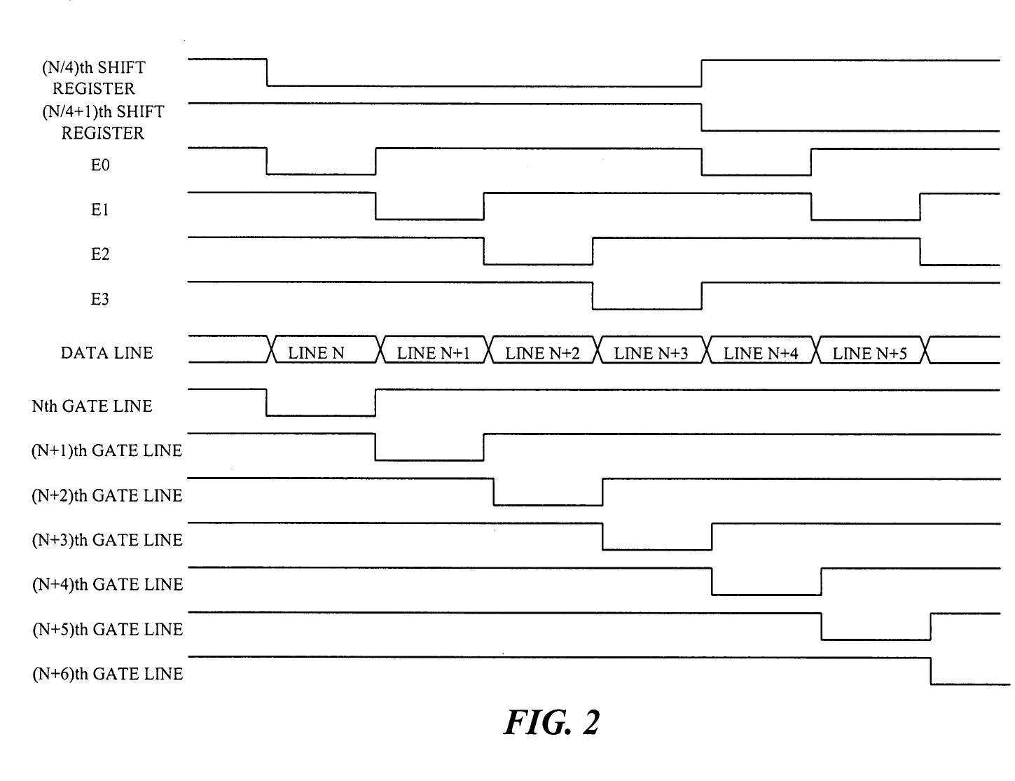

FIG. 2 shows a driving timing chart for the gate driver 1 of FIG. 1. In order to select the Nth line, a selection signal (in this case, Low data) is stored in the (N/4)th shift register. When N is a multiple of 4, E0 is set at Low. When the control line E0 is set at Low, the gate lines 8 of multiples of 4 are connected to the corresponding shift registers 5. However, when the selection signal is only present for one shift register 5 among the shift registers 5, only the Nth line is the data to be selected. By supplying the data of the Nth line to the data line 9, desired data can be appropriately written to the pixel. Because the non-selection signal (in this case, High data) stored in the shift register 5 is reflected to the other lines of multiples of 4, these gate lines are not selected. In the case of normal driving, the data to be supplied to a data line is data of a pixel, and only one of the gate lines 8 is selected.

This process may be considered to be a resolution conversion process in which 4 lines are considered to be 1 line, and the shift register 5 is sequentially updated. In other words, this process is equivalent to a conversion of resolution of QVGA (a width of 240×a length of 320) to resolution of a width of 960×a length of 80 by multiplying in the width direction by 4 and dividing in the length direction by 4. By enabling driving with 80 shift registers as a result, it is possible to secure a margin in the mounting area of the circuit.

Therefore, according to the present embodiment, even when a number of lines is increased due to an increased resolution, the same number of shift registers do not need to be prepared and a mounting area assigned to each shift register can be increased. Thus, it is possible to further improve the performance and speed.

When a portion of the gate driver 1, for example, the shift register 5, is provided as an IC, the first switch 6 and the second switch 7 are preferably formed on the same glass substrate as the pixel 4. In this case, the number of outputs of the driver IC (output of the shift register 5) is reduced to ¼, and connection is facilitated.

In the present embodiment, 4 consecutive lines are considered as a collection (block) and are connected to a shift register. It is also possible to include 2 lines, 3 lines, or 8 lines in a block. In addition, the lines to be included in the block do not need to be consecutive.

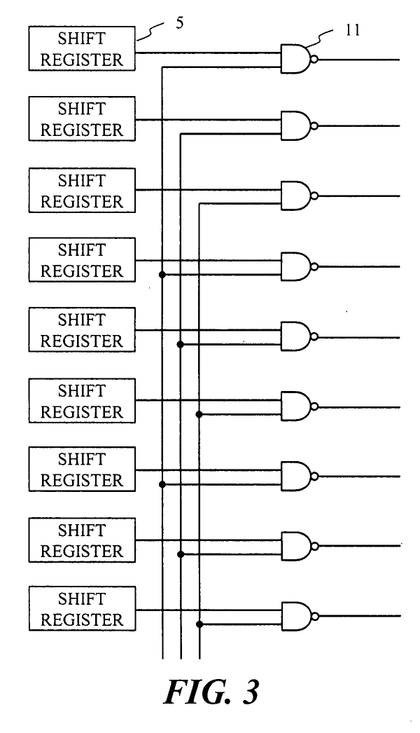

In FIG. 1, the first switch 6 is directly connected to the output of the shift register 5. Alternatively, it is also possible to employ a configuration as shown in FIG. 3, for example, in which the shift register 5 is connected to a logic circuit such as an enable circuit 11 or an output which is controlled through a buffer.

By providing the enable circuit 11 in this manner, it is possible to control whether or not the selection signal is to be output by the enable circuit 11. Thus, it is possible to prohibit output of the selection line for the lines in which the video data is not updated and to stop supply of data for these lines. In addition, with the enable circuit, it is possible to limit a period in which the selection signal is output even within one line and to control reading of data to the pixel within one line.

The data to be supplied to each pixel via the data line 9 may be an analog signal, but is preferably a digital signal. In the case of the digital signal, a period of one frame is divided into a plurality of sub-frames and data is supplied. In case of a monochrome display, the display of sub-frames is not necessary. Therefore, it is preferable to select only a multiple grayscale display region with the enable circuit 11 and supply data.

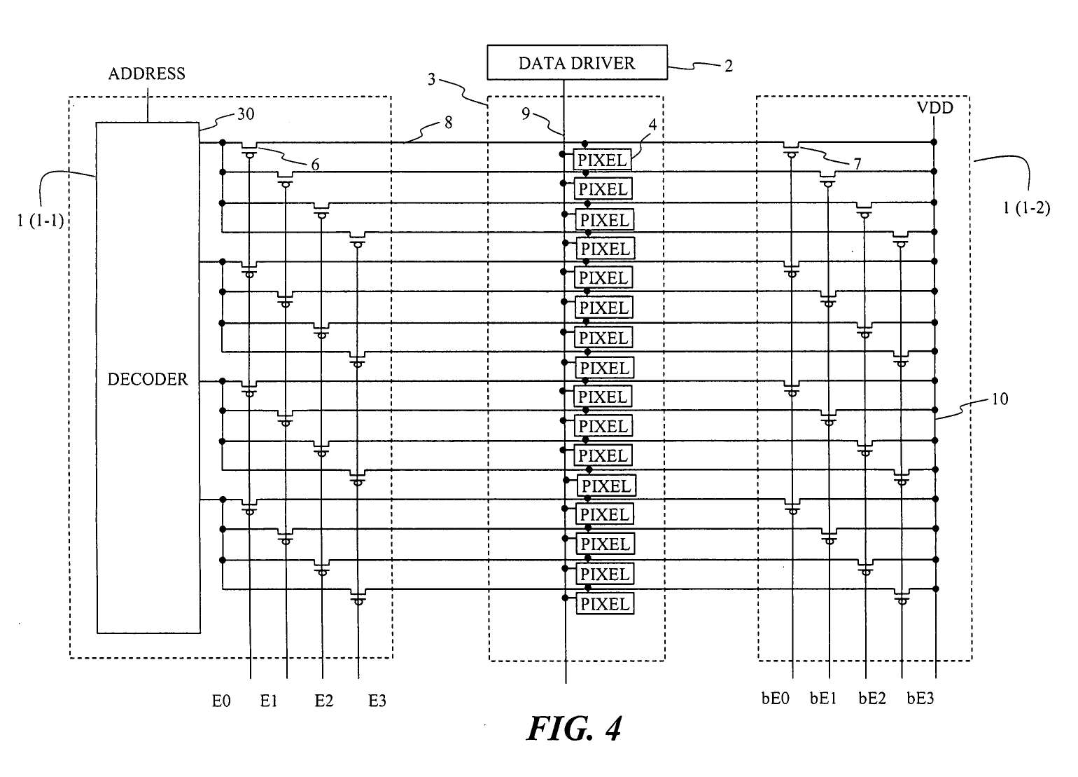

In FIG. 1, an example configuration is shown in which a shift register 5 which sequentially moves the selection signal from an upper line toward a lower line or from a lower line to an upper line with a shift clock is introduced as the selection signal generator to be built in the gate driver. Alternatively, it is also possible to use a decoder 30 which directly designates an arbitrary selection line (address) and generates a signal which selects a corresponding line as shown in FIG. 4.

When the decoder 30 is used, an arbitrary line can be selected without an input of the shift clock, and random access is enabled. In general, because the circuit size of the decoder is increased as the number of lines to be addressed is increased, the decoder is not suited to increasing resolution. However, with the block transfer of an embodiment of the present invention, the number of lines of the selection signal generator can be reduced, and a decoder can be easily applied.

In particular, when a static memory which can be read and written is introduced inside of a pixel, which designates an address with the random accessing because the portion which requires reading or writing can be quickly completed the decoder 30 is efficient for such configurations.

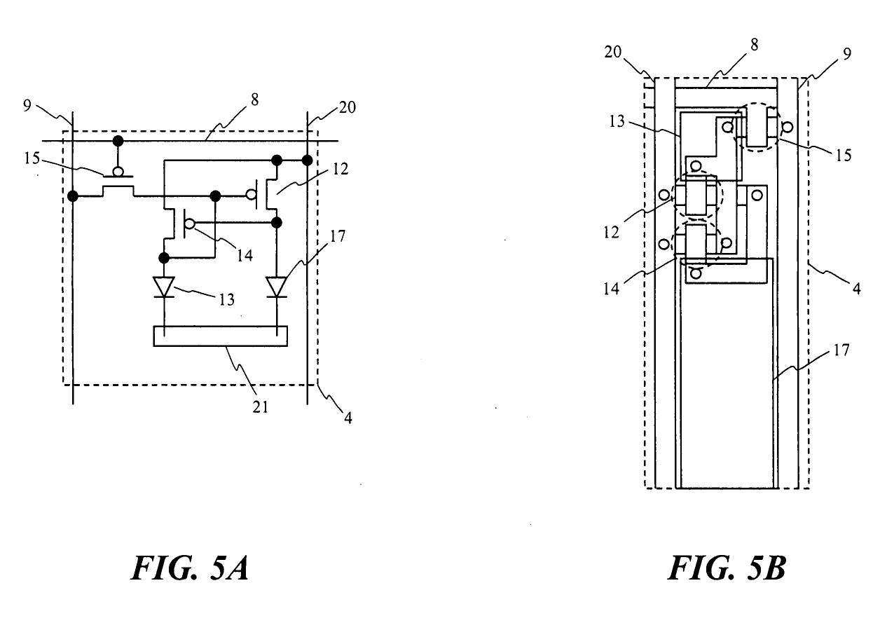

FIG. 5A shows an equivalent circuit of the pixel and FIG. 5B is a diagram showing placement and connection in the pixel circuit seen from a side opposite to the light emission surface, when a static memory is provided in a pixel.

A pixel 4 in FIGS. 5A and 5B includes a first organic EL element 17 which contributes to light emission, a first driving transistor 12 which drives the first organic EL element 17, a second organic EL element 13 which does not contribute to light emission, a second driving transistor 14 which drives the second organic EL element 13, and a gate transistor 15. An anode of the first organic EL element 17 is connected to a drain terminal of the first driving transistor 12 and to a gate terminal of the second driving transistor 14. A gate terminal of the first driving transistor 12 is connected to an anode of the second organic EL element 13, to a drain terminal of the second driving transistor 14, and to a source terminal of the gate transistor 15. A gate terminal of the gate transistor 15 is connected to the gate line 8 and a drain terminal of the gate transistor 15 is connected to the data line 9. Source terminals of the first driving transistor 12 and the second driving transistor 14 are connected to a power supply line 20, and cathodes of the first organic EL element 17 and the second organic EL element 13 are connected to a cathode electrode 21.

When a selection line (Low) is supplied to the gate line, the gate transistor 15 is switched ON, and a data voltage on the data line 9 is supplied to the gate terminal of the first driving transistor 12, to the anode of the second organic EL element 13, and to the drain terminal of the second driving transistor 14.

When the data voltage supplied on the data line 9 is Low, the gate voltage of the first driving transistor 12 is set at Low and the first driving transistor 12 is switched ON. When the first driving transistor 12 is switched ON, the anode of the first organic EL element 17 is connected to the power supply line 20 on which a power supply voltage VDD is supplied, a current flows through the first organic EL element 17, and light is emitted. At the same time, the gate terminal of the second driving transistor 14 is also set at VDD, the second driving transistor 14 is switched OFF, and a potential of the anode of the second organic EL element 13 is dropped to a potential near a cathode potential VSS.

Because the voltage near the cathode potential VSS is supplied to the gate terminal of the first driving transistor 12, the written Low data continues to be maintained while VDD and VSS are being supplied, even after the gate line 8 is set at High and the gate transistor 15 is switched OFF.

When the data voltage is High, the second driving transistor 14 is switched ON, the first driving transistor 12 is switched OFF, and a current flows through the second organic EL element 13. However, because the second organic EL element 13 is light-shielded, light is not emitted. Alternatively, it is also preferable to provide a switching transistor in place of the second organic EL element 13, connect a gate terminal of the switching transistor to the gate of the first driving transistor, and switch the switching transistor OFF when the first driving transistor is switched OFF.

### PARTS LIST

E0 control line
E1 control line
E2 control line
E3 control line
1 gate driver
1-1 controller
1-2 retaining section
2 data driver
3 pixel array
4 pixels
5 shift register
6 first switches
7 second switch
8 gate line
9 data line
10 power supply line
11 enable circuit
12 first driving transistor
13 EL element
14 driving transistor
15 gate transistor
17 EL element
20 power supply line
21 cathode electrode
30 decoder

1. An active matrix display device in which data is supplied to pixels arranged in a matrix form to realize a display, the active matrix display device comprising:
a data driver which supplies data to a data line provided corresponding to a pixel column; and
a selection driver which supplies a selection signal to a selection line provided corresponding to a pixel row, to control reading of data from a corresponding data line in a corresponding pixel, wherein
the selection driver comprises:
a selection signal generator which outputs a selection signal to outputs smaller in number than a number of the selection lines, and
a plurality of selection switches connected to one output of the selection signal generator and which connect the one output to a plurality of the selection lines, and
a plurality of selection switches connected to an output are sequentially switched ON while a selection signal is output from the one output of the selection signal generator so that a selection signal is sequentially output to the plurality of selection lines.

2. The active matrix display device according to claim 1, wherein
the selection signal generator is a shift register which receives supply of a shift clock and which sequentially transfers a selection signal to a register of a plurality of stages.

3. The active matrix display device according to claim 1, wherein
the selection signal generator is a decoder which, when an arbitrary selection line is designated, generates a selection signal which selects a corresponding selection line

4. The active matrix display device according to claim 1, wherein
the selection driver comprises a retaining driver having a retaining switch which is connected to each selection line and which, when the selection switch of the selection line is switched OFF, connects the selection line to a power supply to delete the selection signal.

5. The active matrix display device according to claim 1, wherein
at least one of the selection switch and the retaining switch of the selection driver is formed on a glass substrate.
